(19) United States
(12) Patent Application Publication
(10) Pub. No.: US 2004/0067476 A1
(43) Pub. Date: Apr. 8, 2004

(54) Training device with actuating elements which can be moved continuously in rotation

(76) Inventors: Anton Reck, Betzenweiler (DE); Martin Reck, Betzenweiler (DE)

Correspondence Address: MCKENNA LONG & ALDRIDGE LLP, 1900 K STREET, NW, WASHINGTON, DC, 20006, US

(21) Appl. No.: 10/618,022

(22) Filed: Jul. 14, 2003

(30) Foreign Application Priority Data
Jul. 20, 2002 (DE) 102 33 016.6

(51) Int. Cl. G09B 23/28

(52) U.S. Cl. 434/262

(57) ABSTRACT

A training device (1) is proposed with actuating elements (2, 3) which can be moved continuously in rotation and are connected to one another and are intended for a pair of limbs of a person, which device comprises means (4) for driving and/or braking the actuating elements (2, 3), and an electronics unit (8) for regulating and/or controlling the movement of the actuating elements. According to the invention, the electronics unit (8) is designed to bring the respective speed of the actuating elements, in each case in a portion in the area of dead centers of the rotary movement of the actuating elements, to a predetermined value, preferably to a substantially identical value, but to permit between said portions an acceleration of the actuating elements (2, 3) if a person training applies a targeted torque in a predetermined direction of movement of the actuating elements (2, 3). Alternatively or in addition, in the context of training at a predetermined rotation speed, the electronics unit (8) can accelerate the actuating elements (2, 3), between the portions in the area of the dead centers, to a predetermined higher speed than within the portions, even if no activity by a person training is taking place.

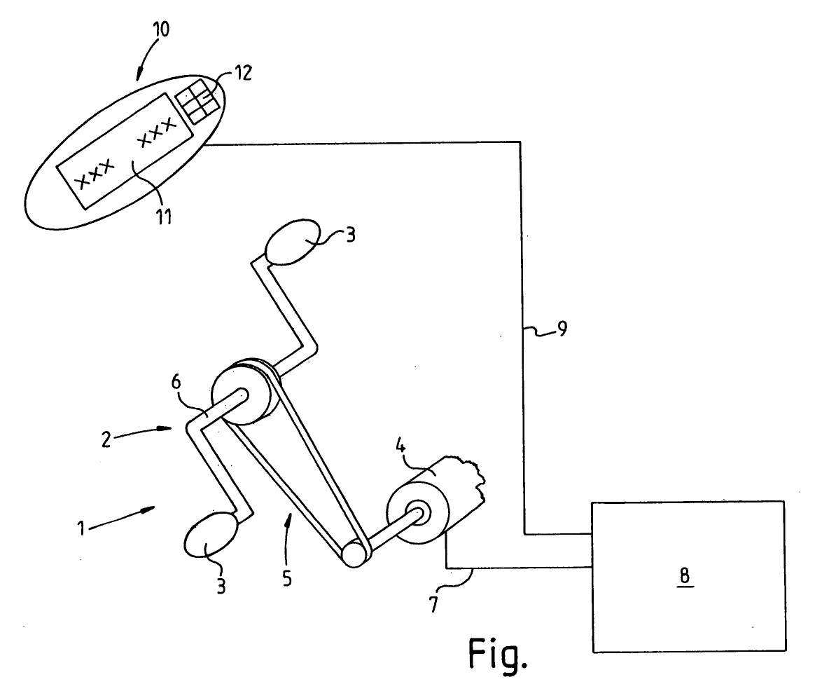

The invention relates to a training device with actuating elements which can be moved continuously in rotation and are connected to one another, in accordance with the preamble of claim 1.

### PRIOR ART

Training devices of the type mentioned above are used in a wide variety of forms, especially in the area of rehabilitation.

European laid-open specification EP 0 865 804 discloses a training device for the physically disabled which is designed in particular for persons who either have very low residual muscle power or who can exert muscle power at least only over part of a revolution. With a conventional training device, such patients would find it difficult to bring about any movement at all, not least a circular movement.

For a more targeted and more conscious movement of one half of the body when using a training device of the type mentioned at the outset, European laid-open specification EP 0 998 961 A1 proposes that an electronics unit be provided which divides the crank movement within one revolution into at least two portions, and that the electronics unit define different functions for the crank movement in relation to these portions.

Many forms of training can be carried out with these two designs. However, they do not provide for any specific power training.

### OBJECT AND ADVANTAGES OF THE INVENTION

The object of the invention is to make available a training device of the type mentioned at the outset, in particular one which permits power training in a way that motivates the person doing the training.

This object is achieved by the features of claims 1 and 2.

Advantageous and expedient developments of the invention are specified in the subclaims.

The invention starts out from a training device with actuating elements which can be moved continuously in rotation and are connected to one another and are intended for a pair of limbs of a person, which device comprises means for driving and/or braking the actuating elements, and an electronics unit for regulating and/or controlling the movement of the actuating elements. The core of the invention now lies in the fact that the electronics unit is designed in such a way that, in a predeterminable training mode, the respective speed of the actuating elements, in each case in a portion in the area of dead centers of the rotary movement, in particular within at least one dead center of a revolution of the rotary movement of the actuating elements, is brought to a predetermined value, preferably to a substantially identical value, but between said portions an acceleration of the actuating elements is permitted if a person training applies a targeted torque in a predetermined direction of movement of the actuating elements. In the case where there is targeted torque application, i.e. when the person training is working actively, an acceleration of the actuating elements takes place from one dead center to the next, but the actuating elements are then braked to a predetermined speed in the area of the next dead center. According to the invention, active training is to be understood as meaning that the total torque on the crank supports the rotary movement or, in the case of training on one side, a supporting torque is applied at least on this side to at least one actuating element. In a continuous pedaling movement on a crank pair, the person training can accelerate twice within a revolution using both dead centers and is braked twice, resulting in a strongly oscillating pedaling movement.

In a further possible alternative embodiment of the invention, the actuating elements, between the portions in the area of the dead centers, are accelerated by the electronics unit to a predetermined higher rotation speed than within the portions, even if no activity is taking place, i.e. no targeted torque application by a person training. In this way, two cases in particular can be realized: In a first one, an, as it were, basic pattern of the actuating element movement is realized even when the person training is passive, i.e. is allowing himself to be moved according to the basic pattern. In this case, it is preferable to ensure that the increase in rotation speed between the portions in the area of the dead centers is considerably below that which a normally active training person would achieve. In this way, a person training is motivated to work actively, and not simply be moved passively, in order to reach a higher rotation speed. A second case concerns the following type of training: On the basis of the basic pattern set, a form of “isokinetic training” is established. That is to say, even when, in the predetermined basic pattern, the person training actuates the actuating elements in a targeted way, the rotation speed profile set by the electronics unit is maintained between the portions. However, in this case, the person training should receive a report of their training input, for example via a suitable display on which the effort applied to the actuating elements can be read off.

The dead center of a crank movement is to be understood as the position of the crank during the crank movement where the torque applied to the crank is at its smallest, i.e. reaches a local low point. In a pedaling movement, there are two dead centers per revolution.

In a further preferred embodiment of the invention, the parameters for a possible rotation speed profile between the portions in the area of the dead centers can be predetermined via the electronics unit. For example, between the portions in extreme power training, a suitably high inertia mass is simulated which can be accelerated only with difficulty. Likewise, it is conceivable initially to permit a great acceleration and, upon further acceleration, a correspondingly high resistance is effective which once again permits power training.

To remain in a power training mode, it is additionally preferable if the respective rotation speed of the actuating elements between the portions in the area of the dead centers is limited to a maximum value in the range of 7 to 17 revolutions.

In a further preferred embodiment of the invention, the electronics unit is designed to bring the actuating elements to a standstill in the respective portions in the area of the dead centers of the actuating element movement. The electronics unit in this connection is preferably designed to change the direction of rotation after each standstill. In this way, an oscillating movement of the actuating elements is obtained, with the result that training can be carried out as in the manner performed using a “leg press”.

To make the training interesting by providing further possibilities for variation, a change in the direction of rotation can also take place after a dead center has been reached two or more times.

### DESCRIPTION OF AN ILLUSTRATIVE EMBODIMENT

An illustrative embodiment of the invention is explained with reference to the single FIGURE, together with further advantages and particulars.

The FIGURE shows a movement device 1 represented diagrammatically in functional blocks. The movement device 1 comprises a crank 2 with pedals 3 for the legs of a person training (not shown), and an electric motor 4 which is connected to a shaft 6 of the crank 2 via a belt drive 5, for example. The electric motor 4 is connected via a connecting line 7 to an electronics unit 8, and the electronics unit 8 is connected via a further connecting line 9 to an input and display unit 10. The input and display arrangement 10 here has a display 11 and an input panel 12.

A person training can start the “power training” via the input panel 12, for example. The crank is then set in motion, for example at a speed of 5 revolutions per minute, with a small increase in rotation speed between each dead center of the pedal movement, for example to 8 revolutions per minute. If a person training now pedals actively on the pedals 3 between the dead centers, even a comparatively small torque application by the person training results in an acceleration to a speed of the pedals which corresponds for example to 15 revolutions per minute. The rotation speed is then limited to this value. In this way, the person training can work in a particularly effective rotation speed range for power training. However, at each dead center the crank movement is always braked again to the basic speed, which corresponds to a “basic rotation speed” of 5 revolutions per minute. This oscillating speed profile gives the user a sensation of movement corresponding to typical power training.

1. A training device (1) with actuating elements (2, 3) which can be moved continuously in rotation and are connected to one another and are intended for a pair of limbs of a person, means (4) for driving and/or braking the actuating elements (2, 3), and an electronics unit (8) for regulating and/or controlling the movement of the actuating elements (2, 3), wherein the electronics unit (8) is designed to bring the respective speed of the actuating elements, in each case in a portion in the area of dead centers of the rotary movement of the actuating elements, to a predetermined value, but to permit between said portions an acceleration of the actuating elements (2, 3) if a person training applies a targeted torque in a predetermined direction of movement of the actuating elements (2, 3).

2. The training device in accordance with the preamble of claim 1, in particular claim 1, wherein the electronics unit (8) is designed to bring the respective speed of the actuating elements, in each case in a portion in the area of dead centers of the rotary movement of the actuating elements, to a predetermined value, preferably to a substantially identical value, and wherein the electronics unit (8) can accelerate the actuating elements (2, 3), between the portions in the area of the dead centers, to a predetermined higher speed than within the portions, even if no activity is taking place, i.e. no targeted torque is being applied by a person training.

3. The training device as claimed in claim 1 or 2, wherein the parameters for a possible rotation speed profile between the portions in the area of the dead centers can be predetermined via the electronics unit (8).

4. The training device as claimed in one of the preceding claims, wherein the respective rotation speed between the portions in the area of the dead centers is limited to a maximum value in the range of 7 to 17 revolutions per minute.

5. The training device as claimed in one of the preceding claims, wherein the electronics unit (8) is designed to bring the actuating elements (2, 3) to a standstill in the respective portion in the area of the dead centers.

6. The training device as claimed in claim 5, wherein the electronics unit (8) is designed to change the direction of rotation of the actuating elements (2, 3) after each standstill.

7. The training device as claimed in claim 5, wherein the electronics unit (8) is designed to change the direction of rotation after a dead center has been reached two or more times.
